(19) United States
(12) Patent Application Publication
(10) Pub. No.: US 2009/0126603 A1
(43) Pub. Date: May 21, 2009

(54) Wax and polymer formulations comprising metallocene-catalyzed polyolefins with and without filler which are particularly suitable for cutting model production processes and also their use for precision casting processes, hollow core production, especially in the dental, jewelry and precision engineering sectors

(75) Inventors: Hermann Diem, Wehringen (DE); Rainer Fell, Gersthofen (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant International Ltd.

(21) Appl. No.: 12/291,701

(22) Filed: Nov. 13, 2008

(30) Foreign Application Priority Data
Nov. 15, 2007 (DE) 102007054 614.0

(51) Int. Cl. C08L 91/08

(52) U.S. Cl. 106/272; 524/570; 524/577; 524/560; 524/555; 524/612

(57) ABSTRACT

Metallocene-catalyzed polyolefins comprising wax and polymer formulations with and without filler are particularly suitable for use in precision casting processes and hollow core production.

The invention relates to wax formulations comprising:
a) metallocene-catalyzed polyolefins having a melting point of from 80° C. to 150° C., a viscosity of from 60 to 20 000 mpa·s at 140° C. and a melt flow index (MFI) of from 30 to 3 000 g/10 min under a load of 2.16 kg and at a test temperature of 230° C.,
b) waxes and wax derivatives having a melting point of from 80° C. to 165° C. and a viscosity of from 50 to 30 000 mPa·s at 140° C.,
c) low density polyolefins (LDPE) having a melting point of from 80° C. to 150° C. and a melt flow index (MFI) of from 30 g/10 min to 3 000 g/10 min measured under a load of 2.16 kg and at a temperature of 230° C.

The wax formulations are used, in particular, for cutting model production processes and hollow core production in the dental, jewelry and precision engineering sectors.

The present invention is described in the German priority application No. 102007054614.0, filed Nov. 15, 2007, which is hereby incorporated by reference as is fully disclosed herein.

Wax and polymer formulations comprising metallocene-catalyzed polyolefins with and without filler which are particularly suitable for cutting model production processes and also their use for precision casting processes, hollow core production, especially in the dental, jewelry and precision engineering sectors

The present invention relates to wax and polymer formulations comprising metallocene-catalyzed polyolefins with and without filler for producing castings which are produced by the precision casting process/lost wax process. The model (positive model/wax model) is produced by shaping (cutting) manufacturing processes (model production processes) such as drilling, turning, filing, milling, planing (shaping on a shaper), rasping, reaming, rubbing, sawing and scraping and also honing, abrasive blasting (lapping), grinding and carving.

### Prior Art

The precision casting process, also known under the name “lost wax” process, has been used for centuries. In the precision casting process, a refractory casting mold is built around the wax model. After construction and drying, the casting mold is heated so that the wax melts and runs out. The casting mold obtained is fired and is then used as negative mold for metal casting. In general, the precision casting process includes a substep (production of the positive model). The model can, in one variant, be produced by injecting a wax into a tool (original mold). The tool is in this case the negative representation of the article to be produced. In this way, wax duplicates are produced as models of the article to be produced as positive. As an alternative, the model (individual or mass-produced models) can be produced from solid material by shaping production techniques such as cutting machining processes.

The subsequent process steps serve to produce a refractory casting mold around the wax model.

Substeps are dipping of the wax model or many wax models adhesively bonded to a bar into a ceramic slurry, subsequent sanding, drying and repetition of these procedures until the desired layer thickness of the shell has been achieved.

After drying of the shell, the wax is then removed by heating. The casting mold is usually heated by means of pressurized steam in autoclaves so that the molten wax can flow out. Atmospheric-pressure processes using other heating methods are also known. After removal of the wax, the ceramic is fired and thus hardened at high temperatures. Residues of the wax are also burnt before the metal is cast. It has to be ensured that all traces of the constituents of the wax formulation are removed from the ceramic casting mold in order to avoid defects on the metal casting. As a next step, molten metal or a metal alloy is cast into the hot casting mold. After cooling and solidification of the metal, the ceramic casting mold is removed from the object which has been cast. The raw casting then undergoes a further finishing process comprising patternation, deflashing and removal of the sprues.

In the production of positive models by cutting machining processes, for example by milling, problems in production are possible if the wax (milling wax) having a specific wax formulation has an unsatisfactory processability in respect of mechanical strength and removal of material. The processability or production of wax models via CNC-controled (computerized numerical control) milling machines has been described, for example, in US 2006/0 004 477 A1. Here, according to the prior art, electronic topological design data are set up via a CAD (computer aided design) or CAM (computer aided manufacturing), processed and made available for CNC-controled (computerized numerical control) shaping machines (milling machine, lathe, etc.) for model production. Wax models are generally produced by machine as a single model through to long runs. In addition, wax models (usually only individual model and short runs) can also be produced manually by cutting machining. In general, a wax formulation not only has to display good cutting machinability but also meet a number of requirements.

To be able to reproduce a workpiece with high dimensional accuracy, the wax formulation has to have a sufficient mechanical strength (hardness, modulus of elasticity, etc.) together with good to very good cutting machinability in order to be able to achieve filigree constructions and correspondingly required surface profiles such as hollow cores with faithful reproduction of detail. In addition, a wax formulation needs to have a very low viscosity during dewaxing and melt out of the negative model without leaving a residue. This is to prevent residues of the wax formulation remaining in the negative model and leading to defects (deformations) in the finished part (casting). The wax formulations are generally melted out at temperatures above 100° C. The firing and hardening of the negative molds (ceramic shells) is carried out at temperatures above 250° C., preferably above 500° C., particularly preferably above 750° C. Since the wax model (positive model) is generally a one-to-one model of the melt casting to be produced, inaccuracies and defects are reproduced in the end product. Wax formulations therefore have to burn without leaving residues and without forming ash or be removed from the negative model in another way. In known wax formulations, properties such as satisfactory mechanical strength and good cutting machinability usually run counter to properties such as good and residue-free dewaxing behavior, small thermal volume changes and smooth true-to-detail surfaces. For a person skilled in the art, it is always a challenge to find the optimum of a wax formulation.

One solution has been to increase the mechanical strength and improve the cutting machinability of the usually paraffin-based wax formulations by addition of various waxes and polymers and by addition of fillers and reinforcing materials. Although the use of fillers and reinforcing materials has improved some properties of the wax formulations for precision casting, but has not been able to solve some existing problems and has also brought new problems. Some of these wax formulations still tended to smear during milling and tend to display a worse dewaxing behavior than wax formulations without fillers and reinforcing materials.

Among various materials proposed for use as fillers for precision casting wax formulations, mention may be made by way of example of crosslinked polystyrene and polyethylene terephthalate, chalk, carbon black, sand. Not all change all relevant physical properties in the right direction. Thus, the polystyrene fillers described in U.S. Pat. No. 3,465,808 have a tendency for the wax to flow out first during dewaxing to leave the polystyrene filler in the cavities, as a result of which the casting mold tends to break open.

The main disadvantage of the use of reactive fillers (e.g. terephthalic acid) is the possibility of, for example, acid to react with constituents of the casting mold and thus adversely affecting the surface quality and also the dimensional accuracy of the castings. Furthermore, a high coefficient of thermal expansion can result in the wax undergoing excessively rapid thermal expansion during dewaxing and the shell of the casting mold therefore cracking.

Although inert, polymeric fillers and additives do not react with constituents of the casting mold, they have a low thermal conductivity and are difficult to remove from the casting mold during dewaxing. Significant ash residues therefore remain in the casting mold on burning of the residual material and these then result in defects on the surface of the casting. Polystyrene, acrylic, polyurethane polymers and polypropylene are often used as inert polymeric fillers. The densities of these fillers are generally above 1 kg/dm³ and are generally significantly higher than the densities of the remaining components of a precision casting wax formulation. As a result, sedimentation processes occur to an increased extent and adversely affect the quality of the precision casting wax formulation.

It was therefore an object of the invention to provide wax formulations for the precision casting process which do not have the abovementioned disadvantages, e.g. poor cutting machinability, unsatisfactory mechanical strength and poor dewaxing behavior, high residual ash contents, thermal conductivity which is very different from the wax base and possible reaction of chemical groups with constituents of the casting mold.

The present object has surprisingly been achieved by a composition which comprises
a) a wax formulation comprising one or more polyolefins having
   a melting point in the range from 80 to 165° C. at a viscosity of <400 mpa·s at 140° C.,
   a ring/ball softening point in the range from 50 to 165° C.,
   a melt viscosity measured at a temperature of 140° C. in the range from 30 to 40.000 mpa·s and
   a glass transition temperature Tg of not more than −10° C., with preference being given to at least one polyolefin having been prepared by metallocene-catalyzed polymerization and
b) if appropriate, one or more fillers, with the melting point of the composition being <165° C., preferably <100° C., at a viscosity of <10.000 mPa·s at 140° C.

The melting point of the composition of the invention is preferably <80° C. at a viscosity of <5.000 mpa·s at 140° C., particularly preferably <10.000 mPa·s at 140° C. The melting point of the polyolefins used is preferably in the range from 80 to 165° C. and in the case of metallocene-catalyzed polyolefins is particularly preferably in the range from 90 to 150° C. at a viscosity of <400 mPa·s at 140° C.

The polyolefins used have a very high enthalpy of fusion in the range from 70 to 280 J/g at densities of from 0.9 kg/dm³ to 0.97 kg/dm³.

In a preferred embodiment, the wax formulation a) contains one or more metallocene-catalyzed polyethylene having a dropping point of <135° C. and a viscosity of 350 mPa·s at 140° C. and also at least one polyolefin (e.g. LDPE=polyolefin with low density) having a melting point range from 100° C. to 150° C. and a melt flow index (MFI) of from 50 g/10 min to 1.000 g/10 min and a load of 2.16 kg and at a test temperature of 190° C. In particular, at least one metallocene-catalyzed polyolefin having a melting point range of from 100° C. to 150° C. and a melt flow index (MFI) of from 30 g/10 min to 3 000 g/10 min under a load of 2.16 kg and at a test temperature of 230° C. is used in place of or in addition to the polyolefins.

The composition of the invention, with or without filler, is particularly suitable for cutting model production processes and their use for precision casting processes, especially in the dental, jewelry and precision engineering sectors. It preferably contains at least one metallocene-catalyzed polyolefin, in particular polyethylenes, preferably in a proportion of from 5 to 100% by weight, particularly preferably in a proportion of from 10 to 80% by weight, very particularly preferably from 25 to 70% by weight, based on the total weight of the formulation.

The polyolefins are preferably prepared by polymerization of ethylene in the presence of metallocenes as catalyst and preferably have a melt index MFI of more than 30 g/10 min, measured in accordance with ISO 1133 at a temperature of 230° C. under a load of 2.16 kg.

The wax formulations used according to the invention preferably comprise polyolefins having melt viscosities measured at a temperature of 170° C. of from 50 to 30 000 mPa·s, preferably from 50 to 20 000 mpa·s, particularly preferably from 50 to 400 mPa·s measured at a temperature of 140° C.

In a preferred embodiment, polyolefins having a number average molar mass Mₙ in the range from 500 to 20 000 g/mol, preferably in the range from 800 to 10 000 g/mol, particularly preferably the range from 1 000 to 5 000 g/mol, and a weight average molar mass M_{w} in the range from 1 000 to 40 000 g/mol, preferably in the range from 1 600 to 30 000 g/mol, particularly preferably in the range from 1 000 to 20 000 g/mol, are used. The molar mass is determined by gel permeation chromatography.

The formulations used according to the invention have the advantage over the wax formulations known from the prior art that they have a significantly better cutting machinability (ability to be milled on a milling machine), display a good tensile strength (tensile N) and stiffness (elongation) at an appropriate hardness without being brittle, at the same time have a favorable viscosity behavior during melting-out of the wax from the negative mold, are toxicologically and ecologically acceptable and can be handled in a simple manner.

The compositions described are adjusted and matched in terms of melting point, viscosity, shrinkage and also hardness and brittleness by methods known to those skilled in the art according to the precise field of use of the precision casting wax formulation.

It is possible to mix paraffins, resins or other functionalized hydrocarbons into the formulation present in the composition.

At least one inorganic filler can be added to the composition of the invention. These can be selected from among many inorganic salts and minerals, with preference being given to sands, chalks, natural milled or precipitated calcium carbonates, calcium-magnesium carbonates, calcium oxide, silicates, barite, graphite and carbon black. Platelet-like fillers such as vermiculite, mica, talc or similar sheet silicates are also suitable as fillers.

The organic fillers can likewise be selected from among many organic compounds (polymers), with preference being given to polystyrene (PS), polymethyl methacrylate (PMMA), polyurethane (PUR), acrylonitrile-butadiene-styrene (ABS) and polycarbonate (PC), which are usually suitably as fillers as fine powder having particle sizes of less than 500 μm.

Fillers and reinforcing materials generally serve to influence the mechanical and thermal properties in a targeted way and to achieve materials and cost savings for the wax formulation. However, the negative effect of the filler on the dewaxing behavior and the increase in the residual ash content of the wax formulation are disadvantages which should not be disregarded.

In a preferred embodiment, the wax formulations comprise polyolefins, in particular metallocene-catalyst polyolefins, which are selected from among homopolymers of propylene and copolymers of propylene and ethylene, with the copolymers preferably comprising from 70 to 99.9% by weight, particularly preferably from 80 to 99% by weight, of one type of olefin.

Furthermore, other waxes, resins or polyolefins, for instance high-pressure polyethylenes (LDPE) as are available, for example, under the name “Lupolene®” from Basell; “Riblenee®” from Polymeri Europa, “Bralene®” from Slovnaft/TVK, etc., can be present. Further possibilities are high-pressure polyethylenes including those containing polar comonomers, e.g. ethylene-vinyl acetate. Preferred polyolefins which have been prepared by metallocene-catalyst polymerization are those available, for example, under the name “Metocene®” from Basell. The formulations produced in this way have a viscosity in the range from 80 to 10 000 mpa·s at 140° C., preferably from 100 to 9 000 mpa·s at 140° C., particularly preferably from 120 to 8 000 mpa·s at 140° C.

If appropriate, pigments, dyes, antioxidants, odor binders, antimicrobial active substances, light stabilizers, aromas and fragrances, mold release agents and additives for increasing/reducing the thermal conductivity and/or increasing/reducing the electrical conductivity (e.g. copper, graphite) can also be present.

To prepare the metallocene-catalyzed polyolefins as are present in the wax formulations used according to the invention, polyolefins are reacted with metallocene compounds of the formula I as catalyst.

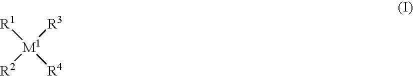

This formula also encompasses compounds of the formula Ia,

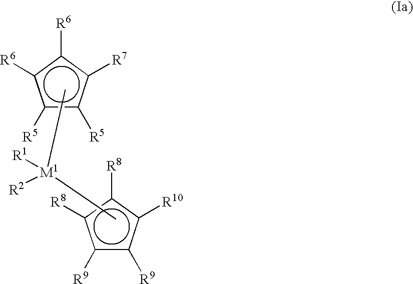

of the formula Ib,

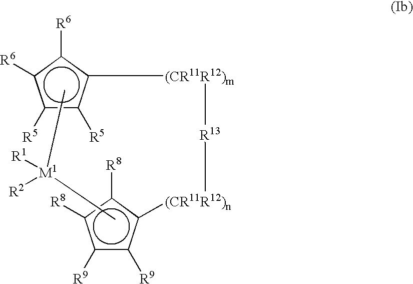

and of the formula Ic.

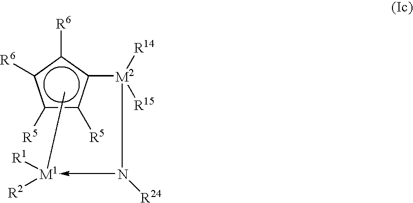

In the formulae I, Ia and Ib, M¹ is a metal of group IVb, Vb or VIb of the Periodic Table, for example titanium, zirconium, hafnium, vanadium, niobium, tantalum, chromium, molybdenum, tungsten, preferably titanium, zirconium and hafnium.

R¹ and R² are identical or different and are each a hydrogen atom, a C₁-C₁₀-, preferably C₁-C₃-alkyl group, in particular methyl, a C₁-C₁₀-, preferably C₁-C₃-alkoxy group, a C₆-C₁₀-, preferably C₆-C₈-aryl group, a C₆-C₁₀-, preferably C₆-C₈-aryloxy group, a C₂-C₁₀-, preferably C₂-C₄-alkenyl group, a C₇-C₄₀-, preferably C₇-C₁₀-arylalkyl group, a C₇-C₄₀-, preferably C₇-C₁₂-alkylaryl group, a C₈-C₄₀-, preferably C₈-C₁₂-arylalkenyl group or a halogen atom, preferably a chlorine atom.

R³ and R⁴ are identical or different and are each a monocyclic or polycyclic hydrocarbon radical which together with the central atom M¹ can form a sandwich structure. R³ and R⁴ are preferably cyclopentadienyl, indenyl, tetrahydroindenyl, benzoindenyl or fluorenyl, where the basic molecules may bear additional substituents or be joined to one another. In addition, one of the radicals R³ and R⁴ can be a substituted nitrogen atom, where R²⁴ has one of the meaning of R¹⁷ and is preferably methyl, tert-butyl or cyclohexyl.

R⁵, R⁶, R⁷, R⁸, R⁹ and R¹⁰ are identical or different and are each a hydrogen atom, a halogen atom, preferably a fluorine, chlorine or bromine atom, a C₁-C₁₀-, preferably C₁-C₄-alkyl group, a C₆-C₁₀-, preferably C₆-C₈-aryl group, a C₁-C₁₀-, preferably C₁-C₃-alkoxy group, an —NR¹⁶₂-, —SR¹⁶-, —OSiR¹⁶₃-, —SiR¹⁶₃- or —PR¹⁶₂ radical, where R¹⁶ is a C₁-C₁₀-, preferably C₁-C₃-alkyl group or C₆-C₁₀-, preferably C₆-C₈-aryl group or in the case of radicals containing Si or P may also be a halogen atom, preferably a chlorine atom, or two adjacent radicals R⁵, R⁶, R⁷, R⁸, R⁹ or R¹⁰ together with the carbon atoms connecting them form a ring. Particularly preferred ligands are the substituted compounds of the basic molecules cyclopentadienyl, indenyl, tetrahydroindenyl, benzoindenyl or fluorenyl.

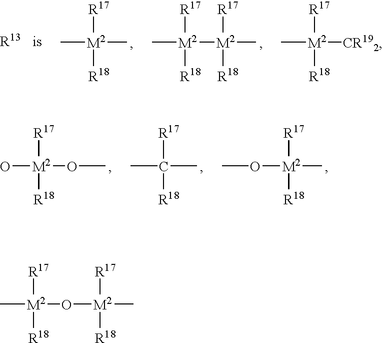

═BR¹⁷, ═AIR¹⁷, —Ge—, —Sn—, —O—, —S—, ═SO, ═SO₂, ═NR¹⁷, ═CO, ═PR¹⁷ or ═P(O)R¹⁷, where R¹⁷, R¹⁸ and R¹⁹ are identical or different and are each a hydrogen atom, a halogen atom, preferably a fluorine, chlorine or bromine atom, a C₁-C₃₀-, preferably C₁-C₄-alkyl group, in particular a methyl group, a C₁-C₁₀-fluoroalkyl group, preferably a CF₃ group, a C₆-C₁₀-fluoroaryl group, preferably a pentafluorophenyl group, a C₆-C₁₀-, preferably C₆-C₈-aryl group, a C₁-C₁₀-, preferably C₁-C₄-alkoxy group, in particular a methoxy group, a C₂-C₁₀-, preferably C₂-C₄-alkenyl group, a C₇-C₄₀-, preferably C₇-C₁₀-aralkyl group, a C₈-C₄₀-, preferably C₈-C₁₂-arylalkenyl group or a C₇-C₄₀-, preferably C₇-C₁₂-alkylaryl group, or R¹⁷ and R¹⁸ or R¹⁷ and R¹⁹ in each case together with the atoms connecting them form a ring.

M² is silicon, germanium or tin, preferably silicon or germanium. R¹³ is preferably ═CR¹⁷R¹⁸, ═SiR¹⁷R¹⁸, ═GeR¹⁷R¹⁸, —O—, —S—, ═SO, ═PR¹⁷ or ═P(O)R¹⁷.

R¹¹ and R¹² are identical or different and have one of the meanings of R¹⁷. m and n are identical or different and are each zero, 1 or 2, preferably zero or 1, where m plus n is zero, 1 or 2, preferably zero or 1.

R¹⁴ and R¹⁵ have the meanings of R¹⁷ and R¹⁸.

Specific examples of suitable metallocenes are:
bis(1,2,3-trimethylcyclopentadienyl)zirconium dichloride,
bis(1,2,4-trimethylcyclopentadienyl)zirconium dichloride,
bis(1,2-dimethylcyclopentadienyl)zirconium dichloride,
bis(1,3-dimethylcyclopentadienyl)zirconium dichloride,
bis(1-methylindenyl)zirconium dichloride,
bis(1-n-butyl-3-methylcyclopentadienyl)zirconium dichloride,
bis(2-methyl-4,6-di-i-propylindenyl)zirconium dichloride,
bis(2-methylindenyl)zirconium dichloride,
bis(4-methylindenyl)zirconium dichloride,
bis(5-methylindenyl)zirconium dichloride,
bis(alkylcyclopentadienyl)zirconium dichloride,
bis(alkylindenyl)zirconium dichloride,
bis(cyclopentadienyl)zirconium dichloride,
bis(indenyl)zirconium dichloride,
bis(methylcyclopentadienyl)zirconium dichloride,
bis(n-butylcyclopentadienyl)zirconium dichloride,
bis(octadecylcyclopentadienyl)zirconium dichloride,
bis(pentamethylcyclopentadienyl)zirconium dichloride,
bis(trimethylsilylcyclopentadienyl)zirconium dichloride,
biscyclopentadienylzirconiumdibenzyl,
biscyclopentadienylzirconiumdimethyl,
bistetrahydroindenylzirconium dichloride,
dimethylsilyl-9-fluorenylcyclopentadienylzirconium dichloride,
dimethylsilylbis-1-(2,3,5-trimethylcyclopentadienyl)zirconium dichloride,
dimethylsilylbis-1-(2,4-dimethylcyclopentadienyl)zirconium dichloride,
dimethylsilylbis-1-(2-methyl-4,5-benzoindenyl)zirconium dichloride,
dimethylsilylbis-1-(2-methyl-4-ethylindenyl)zirconium dichloride,
dimethylsilylbis-1-(2-methyl-4-i-propylindenyl)zirconium dichloride,
dimethylsilylbis-1-(2-methyl-4-phenylindenyl)zirconium dichloride,
dimethylsilylbis-1-(2-methyl-indenyl)zirconium dichloride,
dimethylsilylbis-1-(2-methyltetrahydroindenyl)zirconium dichloride,
dimethylsilylbis-1-indenylzirconium dichloride,
dimethylsilylbis-1-indenylzirconiumdimethyl,
dimethylsilylbis-1-tetrahydroindenylzirconium dichloride,
diphenylmethylen-9-fluorenylcyclopentadienylzirconium dichloride,
diphenylsilylbis-1-indenylzirconium dichloride,
ethylenebis-1-(2-methyl-4,5-benzoindenyl)zirconium dichloride,
ethylenebis-1-(2-methyl-4-phenylindenyl)zirconium dichloride,
ethylenebis-1-(2-methyltetrahydroindenyl)zirconium dichloride,
ethylenebis-1-(4,7-dimethylindenyl)zirconium dichloride,
ethylenebis-1-indenylzirconium dichloride,
ethylenebis-1-tetrahydroindenylzirconium dichloride,
indenylcyclopentadienylzirconium dichloride
isopropylidene(1-indenyl)(cyclopentadienyl)zirconium dichloride,
isopropylidene(9-fluorenyl)(cyclopentadienyl)zirconium dichloride,
phenylmethylsilylbis-1-(2-methyl-indenyl)zirconium dichloride,
   and also the alkyl or aryl derivatives of each of these metallocene dichlorides.

To activate the single-site catalyst systems, suitable cocatalysts are used. Suitable cocatalysts for metallocenes of the formula I are organoaluminum compounds, in particular aluminoxanes, or else aluminum-free systems such as R²⁰ₓNH₄₋ₓBR²¹₄, R²⁰ₓPH₄₋ₓBR²¹₄, R²⁰₃CBR²¹₄ or BR²¹₃. In these formulae, x is from 1 to 4, the radicals R²⁰ are identical or different, preferably identical, and are each C₁-C₁₀-alkyl or C₆-C₁₈-aryl or two radicals R²⁰ together with the atoms connecting them form a ring, and the radicals R²¹ are identical or different, preferably identical, and are each C₆-C₁₈-aryl which may be substituted by alkyl, haloalkyl or fluorine. In particular, R²⁰ is ethyl, propyl, butyl or phenyl and R²¹ is phenyl, pentafluorophenyl, 3,5-bis-trifluoromethylphenyl, mesityl, xylyl or tolyl.

In addition, a third component is frequently necessary to maintain protection against polar catalyst poisons. Organoaluminum compounds such as triethylaluminum, tributylaluminum and others and also mixtures of these are suitable for this purpose.

Depending on the process, supported signal-side catalysts can also be used. Preference is given to catalyst systems in which the residual content of support material and cocatalysts in the product do not exceed a concentration of 100 ppm.

Processes for preparing such metallocene-catalyzed polyolefins are described, for example, in the prior art, e.g. EP-A-0 321 851, EP-A-0 321 852, EP-A-0 384 264, EP-A-0 571 882 and EP-A-0 890 584.

The synthesis of the metallocene-catalyzed polyolefins can be carried out under a pressure of from 0.1 to 10 MPa in the gas phase or in suspension or in solution in a suitable suspension medium/solvent according to known technologies.

Metallocene catalysts for preparing metallocene-catalyzed polyolefins are chiral or achiral transition metal compounds of the formula M¹Lₓ. The transition metal compound M¹Lₓ contains at least one central metal atom M¹ to which at least one π-ligand, e.g. a cyclopentadienyl ligand, is bound. In addition, substituents such as halogen, alkyl, alkoxy or aryl groups can be bound to the central metal atom M¹. M¹ is preferably an element of main group III, IV, V or VI of the Periodic Table of the Elements, e.g. Ti, Zr or Hf. The term cyclopentadienyl ligand encompasses unsubstituted cyclopentadienyl radicals and substituted cyclopentadienyl radicals such as methylcyclopentadienyl, indenyl, 2-methylindenyl, 2-methyl-4-phenylindenyl, tetrahydroindenyl or octahydrofluorenyl radicals. The π-ligands can be bridged or unbridged, with single and multiple bridges, including ring systems, being possible. The term metallocene also encompasses compounds having more than one metallocene fragment, known as multinuclene metallocenes. These can have any substitution pattern and bridging variants. The individual metallocene fragments of such mutlinuclene metallocenes can be of the same type or be different from one another. Examples of such multinuclene metallocenes are, for example, described in EP-A-0 632 063.

Examples of general structural formulae of metallocenes and of their activation by means of a cocatalyst are given, inter alia, in EP-A-0 571 882.

Since the wax formulation which is present according to the invention does not contain any reactive chemical groups, it is chemically inert so that no chemical reaction takes place with other commercial materials such as metals and plastics, which is desirable with regard to the design of the components and tools and their life.

The wax formulations are preferably used in the form of pelletized material or powder. Three-dimensional bodies such as preforms, blanks, plates, profiles and blocks can be formed without problems from this.

The following examples illustrate the invention without restricting it to the specific embodiments described. Percentages are, unless indicated otherwise, percentages by weight.

### EXAMPLES

The melt viscosities were determined in accordance with DIN 53019 using a rotational viscometer, the dropping points were determined in accordance with ASTM D3954, the ring/ball softening points were determined in accordance with ASTM D3104 in the case of pure Licocene® Performance Polymers. The weight average molar mass M_{w} and the number average molar mass Mₙ were determined by gel permeation chromatography at a temperature of 135° C. in 1,2-dichlorobenzene.

The metallocene-catalyzed polyolefin (Licocene® Performance Polymer) used according to the invention was prepared by methods reported in the prior art (EP 0 384 264).

The manufacturer of the waxes and metallocene-catalyzed polyolefins mentioned (Licocene® Performance Polymers) is Clariant Produkte (Deutschland) GmbH.

Paraffins:
Paraffins having side chains of C₂₀ and above
Microcrystalline paraffins
Macrocrystalline paraffins
FT paraffins (Fischer-Tropsch)

Resins:
Natural resins
Synthetic resins

Metallocene-catalyzed polyolefins:
Licocene® PE 4201 TP
Licocene® PE 5301 TP
Licocene® PP 6102 TP
Licocene® PP 6502 TP
Licocene® PP 7502 TP
Metocene® from Basell

Waxes:
Nonpolar polyethylene waxes:
Licowax® PE 130
Licowax® PE 190
Licowax® PE 520

Nonpolar polypropylene waxes:
Licowax® PP 220
Licowax® PP 230

Polar polyethylene waxes:
Licowax® PED 121
Licowax® PED 153
Licowax® PED 522

Reaction products of fatty acids and polyfunctional diamines (amide waxes), e.g.:
Ethylene bisstearamide
Licowax® C

Montanic acid and montanic esters:
Licowax® E
Licowax® S
Licowax® OP
Licowax® LP
Licowax® KP

Low density polyolefins (LDPE):
Bralen® from Slovnaft/TVK
Lupolen® from Basell
Riblene® from Polimeri Europa

The melt viscosities were determined in accordance with DIN 53019 using a rotational viscometer, the dropping points were determined in accordance with ASTM D3954, the ring/ball softening points were determined in accordance with ASTM D3104. The weight average molar mass M_{w} and the number average molar mass Mₙ were determined by gel permeation chromatography at a temperature of 135° C. in 1,2-dichlorobenzene (in the case of Licocene® Performance Polymer).

### Example 1

A precision casting wax formulation was produced from the following components:
70% of Licocene® PE 4201 (metallocene-catalyzed polyolefin)
30% of Riblenene® FL 30 (low density polyolefin, LDPE)

The material is characterized by a softening point of about 150° C. and a dynamic viscosity of about 4 000 mpa·s at 140° C. Mechanical tests on standard test specimens gave the following measured values:

A ball indentation hardness (DIN 51920):

| | | | | Hardness | | | |
|---|---|---|---|---|---|---|---|
| | | Penetration | | DGF M- | Based on | | |
| Load | Ball | depth (μm) | | III 9c | ISO | Proportion (%) | |
| (kg) | diameter (mm) | Loading | Unloading | (98) [bar] | 2039-1 | Elastic | Plastic |
| 10 | 0.005 | 205 | 130 | 75 | 30 | 35 | 65 |

Density: 0.92 g/ml

### Example 2

A precision casting wax formulation was produced from the following components:
70% of Licocene® PE 4201 (metallocene-catalyzed polyolefin)
30% of Bralen® SA 70-21 (low density polyolefin, LDPE)

The material is characterized by a softening point of about 130° C. and a dynamic viscosity of about 2 300 mPa·s at 140° C. Mechanical tests on standard test specimens gave the following measured values:

A ball indentation hardness (DIN 51920):

| | | | | Hardness | | | |
|---|---|---|---|---|---|---|---|
| | | Penetration | | DGF M- | Based on | | |
| Load | Ball | depth (μm) | | III 9c | ISO | Proportion (%) | |
| (kg) | diameter (mm) | Loading | Unloading | (98) [bar] | 2039-1 | Elastic | Plastic |
| 10 | 0.005 | 208 | 131 | 30 | 30 | 37 | 63 |

Density: 0.92 g/ml

### Example 3

A precision casting wax formulation was produced from the following components:
70% of Licocene® PE 4201 (metallocene-catalyzed polyolefin)
30% of Bralen® SA 200-22 (low density polyolefin, LDPE)

The material is characterized by a softening point of about 128° C. and a dynamic viscosity of about 1 500 mPa·s at 140° C. Mechanical tests on standard test specimens gave the following measured values:

A ball indentation hardness (DIN 51920):

| | | | | Hardness | | | |
|---|---|---|---|---|---|---|---|
| | | Penetration | | DGF M- | Based on | | |
| Load | Ball | depth (μm) | | III 9c | ISO | Proportion (%) | |
| (kg) | diameter (mm) | Loading | Unloading | (98) [bar] | 2039-1 | Elastic | Plastic |
| 10 | 0.005 | 212 | 138 | 31 | 30 | 35 | 65 |

Density: 0.93 g/ml

### Example 4

A precision casting wax formulation was produced from the following components:
70% of Licocene® PE 4201 (metallocene-catalyzed polyolefin)
30% of Metocene® HM 1423 (metallocene-catalyzed polyolefin)

The material is characterized by a softening point of about 148° C. and a dynamic viscosity of about 1 150 mPa·s at 140° C. Mechanical tests on standard test specimens gave the following measured values:

A ball indentation hardness (DIN 51920):

| | | | | Hardness | | | |
|---|---|---|---|---|---|---|---|
| | | Penetration | | DGF M- | Based on | | |
| Load | Ball | depth (μm) | | III 9c | ISO | Proportion (%) | |
| (kg) | diameter (mm) | Loading | Unloading | (98) [bar] | 2039-1 | Elastic | Plastic |
| 10 | 0.005 | 135 | 90 | 47 | 47 | 33 | 67 |

Density: 0.94 g/ml

### Example 5

A precision casting wax formulation was produced from the following components:
70% of Licocene® PE 4201 (metallocene-catalyzed polyolefin)
30% of Metocene® HM 1425 (metallocene-catalyzed polyolefin)

The material is characterized by a softening point of about 147° C. and a dynamic viscosity of about 850 mpa·s at 140° C. Mechanical tests on standard test specimens gave the following measured values:

A ball indentation hardness (DIN 51920):

| | | | | Hardness | | | |
|---|---|---|---|---|---|---|---|
| | | Penetration | | DGF M- | Based on | | |
| Load | Ball | depth (μm) | | III 9c | ISO | Proportion (%) | |
| (kg) | diameter (mm) | Loading | Unloading | (98) [bar] | 2039-1 | Elastic | Plastic |
| 10 | 0.005 | 125 | 106 | 50 | 50 | 16 | 84 |

Density: 0.94 g/ml

### Example 6

A precision casting wax formulation was produced from the following components:
70% of Licocene® PE 4201 (metallocene-catalyzed polyolefin)
20% of Metocene® HM 1425 (metallocene-catalyzed polyolefin)
10% of graphite powder

The material is characterized by a softening point of about 147° C. and a dynamic viscosity of about 1 100 mpa·s at 140° C. Mechanical tests on standard test specimens gave the following measured values:

A ball indentation hardness (DIN 51920):

| | | | | Hardness | | | |
|---|---|---|---|---|---|---|---|
| | | Penetration | | DGF M- | Based on | | |
| Load | Ball | depth (μm) | | III 9c | ISO | Proportion (%) | |
| (kg) | diameter (mm) | Loading | Unloading | (98) [bar] | 2039-1 | Elastic | Plastic |
| 10 | 0.005 | 125 | 106 | 73 | 50 | 15 | 85 |

Density: 1.01 g/ml

### Example 7

A precision casting wax formulation was produced from the following components:
68% of Licocene® PE 4201 (metallocene-catalyzed polyolefin)
30% of Metocene® HM 1425 (metallocene-catalyzed polyolefin)
10% of Licocene® PP 7502 fine powder (metallocene-catalyzed polyolefin)

The material is characterized by a softening point of about 153° C. and a dynamic viscosity of about 750 mpa·s at 140° C. Mechanical tests on standard test specimens gave the following measured values:

A ball indentation hardness (DIN 51920):

| | | | | Hardness | | | |
|---|---|---|---|---|---|---|---|
| | | Penetration | | DGF M- | Based on | | |
| Load | Ball | depth (μm) | | III 9c | ISO | Proportion (%) | |
| (kg) | diameter (mm) | Loading | Unloading | (98) [bar] | 2039-1 | Elastic | Plastic |
| 10 | 0.005 | 125 | 106 | 73 | 50 | 10 | 90 |

Density: 0.94 g/ml

1. A composition comprising
a.) a wax formulation comprising one or more polyolefins having
a melting point in the range from 80 to 165° C. at a viscosity of <400 mPa·s at 140° C.,
a ring/ball softening point in the range from 50 to 165° C.,
a melt viscosity measured at a temperature of 140° C. in the range from 30 to 40.000 mPa·s and
a glass transition temperature Tg of not more than −10° C., wherein, optionally, the at least one polyolefin is prepared by metallocene-catalyzed polymerization and
b) optionally, one or more fillers, with the melting point of the composition being <165° C., at a viscosity of <10.000 mPa·s at 140° C.

2. The composition as claimed in claim 1, wherein the enthalpy of fusion of the one or more polyolefins is in the range from 70 to 280 J/g at densities of from 0.90 to 0.97 kg/dm³.

3. The composition as claimed in claim 1, wherein the wax formulation a) contains metallocene-catalyzed polyolefins in a ratio of from 5 to 100% by weight based on the total weight of the wax formulation.

4. The composition as claimed in claim 1, wherein the one or more polyolefins have melt viscosities of from 50 to 30 000 mpa·s at a temperature of 170° C.

5. The composition as claimed in claim 1, wherein the one or more polyolefins have a number average molar mass Mn in the range from 500 to 20 000 g/mol and a weight average molar mass Mw in the range from 1 000 to 40 000 g/mol.

6. The composition as claimed in claim 1, wherein the one or more fillers is at least one inorganic filler selected from the following group consisting of: inorganic salts and minerals.

7. The composition as claimed in claim 1, wherein the one or more fillers comprise at least one organic filler selected from the group consisting of: polyolefins (PO), polystyrene (PS), polymethyl methacrylate (PMMA), polyurethane (PUR), acrylonitrile-butadiene-styrene (ABS) and polycarbonate (PC).

8. The composition as claimed in claim 1, wherein the wax formulation a) comprises metallocene-catalyzed polyolefins, wherein the metallocene-catalyzed polyolefins are homopolymers of propylene and copolymers of propylene and ethylene, with the copolymers comprising from 70 to 99.9% by weight, of one type of olefin.

9. The composition as claimed in claim 1, wherein the composition further comprises at least one of the following compounds, wherein the at least one of the following compounds is selected from the group consisting of waxes, resins, pigments, dyes, antioxidants, odor binders, antimicrobial active substances, light stabilizers, aromas, fragrances, mold release agents, additives for increasing or reducing thermal conductivity and additives for increasing or reducing electrical conductivity.

10. A cutting model production process, a precision casting process or a hollow core production process comprising the step of using a composition as claimed in claim 1 during the cutting model production process, precision casting process or hollow core production process.

11. The composition as claimed in claim 1, wherein the at least one polyolefin is prepared by metallocene-catalyzed polymerization.

12. The composition as claimed in claim 1, wherein the melting point of the composition is <100° C.

13. The composition as claimed in claim 6, wherein inorganic salts and minerals are selected from the group consisting of sands, chalks, natural milled or precipitated calcium carbonates, calcium-magnesium carbonates, calcium oxide, silicates, barite, graphite, carbon black, vermiculite, mica, talc and sheet silicates.

14. The composition as claimed in claim 8, wherein the copolymers comprise 80 to 99% by weight, of one type of olefin.

15. A cutting model production, a precision casting or a hollow core production made in accordance with the process of claim 10.
